(19) United States
(12) Patent Application Publication
(10) Pub. No.: US 2010/0294889 A1
(43) Pub. Date: Nov. 25, 2010

(54) DEVICE FOR JOINING TORSION BOXES OF AIRCRAFT

(75) Inventors: Alberto BALSA GONZÁLEZ, Madrid (ES); Francisco de Paula BURGOS GALLEGO, Madrid (ES)

Correspondence Address: OBLON, SPIVAK, MCCLELLAND MAIER & NEUSTADT, L.L.P., 1940 DUKE STREET, ALEXANDRIA, VA, 22314, US

(73) Assignee: AIRBUS Operations S.L., Madrid (ES)

(21) Appl. No.: 12/710,819

(22) Filed: Feb. 23, 2010

(30) Foreign Application Priority Data
May 22, 2009 (ES) 200901269

(51) Int. Cl. B64C 1/06

(52) U.S. Cl. 244/131

(57) ABSTRACT

The invention relates to a device (1) for joining torsion boxes (5, 6) of aircraft structures, said structures carrying fuel therein, characterized in that the mentioned device (1) comprises three sides (2, 3, 4) by means of which it is secured to the inner part of the structural parts of the joint of the torsion boxes (5, 6) of the aircraft in a permanent manner, said device (1) thus closing the joint of the boxes (5, 6) and preventing possible fuel leaks, the device (1) being a non-structural component of the mentioned joint since it does not withstand the loads of the structure of the joint of torsion boxes (5, 6).

### FIELD OF THE INVENTION

The present invention relates to a device which allows joining torsion boxes of aircraft structures, particularly of structures carrying fuel therein, such that fuel leaks during the operative life of the aircraft are prevented.

### BACKGROUND OF THE INVENTION

A torsion box consists of two skins which are applied to a central or inner material (core), generally a mesh or a grid of the same type. The torsion box functions similarly to a beam, although it is considerably lighter than a solid beam of the same size, without losing much strength. Torsion boxes are used in building fuselages or aircraft structures, particularly in wings and in vertical and horizontal stabilizers.

Joining the torsion boxes of those elements of the aircraft carrying fuel therein has a number of problems with respect to leaks. Leaks usually occur when joining torsion boxes both in the rear part of the joint and in the front part thereof. These leaks occur due to the geometry itself of the parts forming the mentioned boxes, since these parts generate cavities or gaps when they are joined, these cavities serving as a path for the fuel housed inside said boxes.

There are several defined problematic areas and these leak problems are solved today with a methodology prone to improvement. Today, this type of leak is handled in several ways; one of them consists of flooding the area in which there are cavities or gaps of a material acting as a sealant. Another one of the known solutions consists of using a part with a special design which covers most of the possible surface in which the cavities or gaps exist, such that the amount of sealant material which is necessary to apply is slightly reduced. In both cases, the leak is dealt with at the end of its path and with rather ineffective methods, since the application of a large amount of sealant material causes it to crack over time, which causes the occurrence of new leak paths for the fuel.

In addition to the sealant cracking, as can be seen in the previous example, the parts with a special design are secured to the structure of the torsion box only by means of the grip of the sealant material itself. Due to the operative life itself of the aircraft, which is subjected to loads and vibrations, this solution generates a number of problems during the maintenance of the aircraft, it even being necessary to remove all the sealant material applied and again installing new parts again embedded in a large amount of sealant material in the event that the original material is cracked and the sealing part is loose. This solution therefore presents a number of problems with respect to costs and times.

Sealing devices are known, such as the one described in document U.S. Pat. No. 6,073,889 for example, which improve the aerodynamics of the aircraft, preventing jumps in the external airflow in contact with the surface of the airplane (increasing the aerodynamic efficiency of the airplane). However, devices intended for sealing fuel leaks of an aircraft are not known.

The present invention offers a solution to the previously mentioned problems.

### SUMMARY OF THE INVENTION

Thus, the invention develops a device for joining torsion boxes of aircraft structures, said structures carrying fuel therein, said devices preventing fuel leaks during the entire operative life of the aircraft. Thus, the device of the invention comprises three sides, said device being placed in the inner part of the joint of the torsion boxes, said device furthermore being installed during the step of the process of assembling the torsion boxes, and in a permanent manner, thus preventing future problems in the service life of the aircraft.

One of the essential features of the device of the invention for joining torsion boxes is the fact that it is a non-structural component of the mentioned joint, which allows assuring perfect sealing of said joint. The device of the invention is non-structural because it does not withstand the loads existing in the mentioned structure. One way to make the device not withstand stresses is by making the borehole in which the rivet for securing the mentioned device to the other parts is arranged slightly larger than the diameter of said rivet. The structural parts of the joint of torsion boxes of structures of the aircraft must withstand high loads or forces to which these structures are subjected, so they require a perfect support between the sides forming them with the adjacent parts. Achieving this perfect support with parts having three sides is very complex. Since the device of the invention is not structural, the support of the mentioned device does not have to be perfect, there being able to be small allowances between its three sides and the adjacent parts, it only being necessary to cover these minimum allowances with sealant material to assure a perfect sealing during the entire useful service life of the aircraft.

Other features and advantages of the present invention will be understood from the following detailed description of its object in relation to the attached drawings.

### DESCRIPTION OF THE DRAWINGS

FIG. 1 shows a schematic view of the joint of torsion boxes by means of the use of a sealing part according to the known prior art.

FIG. 2 shows a detail of FIG. 1, which shows the areas which will be flooded with sealant material according to the known prior art.

FIG. 3 shows a schematic view of the inside of the joint of torsion boxes of an aircraft in which the device of the invention will be installed.

FIG. 4 shows a detail of the cavity or gap generated in the joint of torsion boxes, which will be a possible path for the fuel leak.

FIG. 5 shows a detail of the device for joining torsion boxes according to the present invention placed in said joint and seen from the inside thereof.

FIG. 6 shows a detail of the device of the invention for joining torsion boxes.

### DETAILED DESCRIPTION OF THE INVENTION

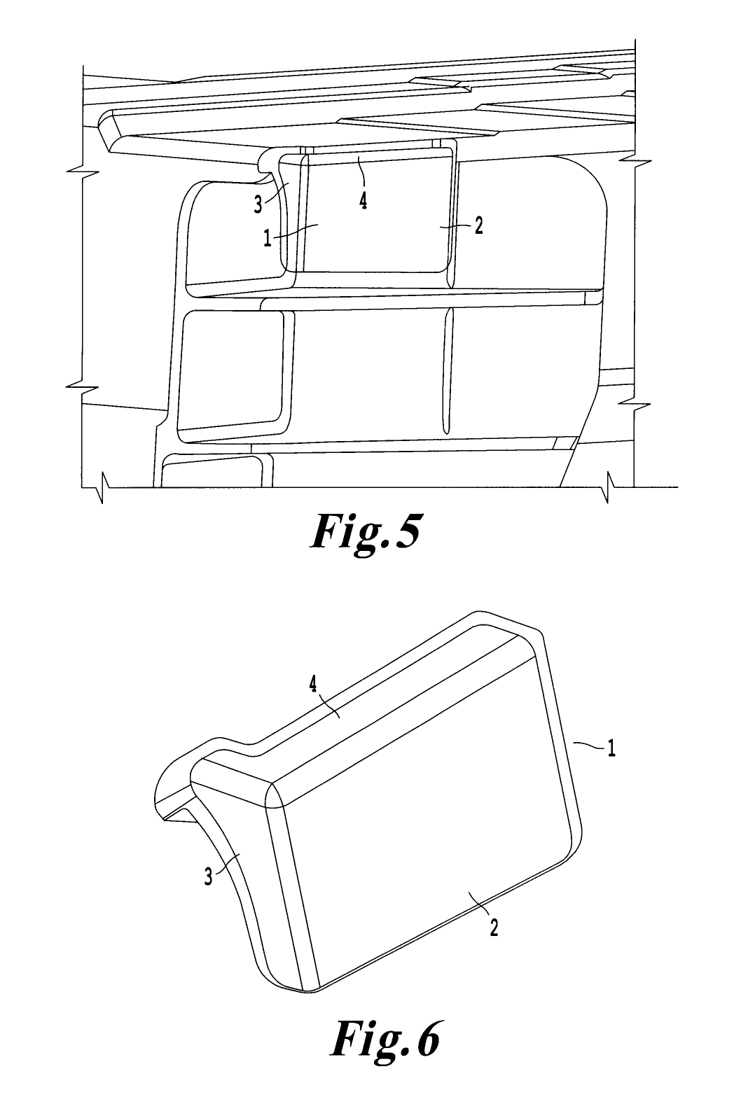

The present invention develops a device 1 for joining torsion boxes 5, 6 of aircraft structures, said structures carrying fuel therein, said devices 1 preventing fuel leaks during the entire operative life of the aircraft. The device 1 comprises three sides, 2, 3 and 4 (shown in detail in FIG. 6) said device 1 being placed in the inner part (as shown in FIG. 5) of the joint of the torsion boxes 5 and 6, said device 1 furthermore being installed during the step of the process of assembling the mentioned torsion boxes 5 and 6, and in a permanent manner, thus preventing future problems in the service life of the aircraft. As shown in detail in FIG. 6, the closure formed by the three sides, 2, 3 and 4 of the device 1 prevents possible fuel leaks once it is arranged in the joint of the torsion boxes 5 and 6.

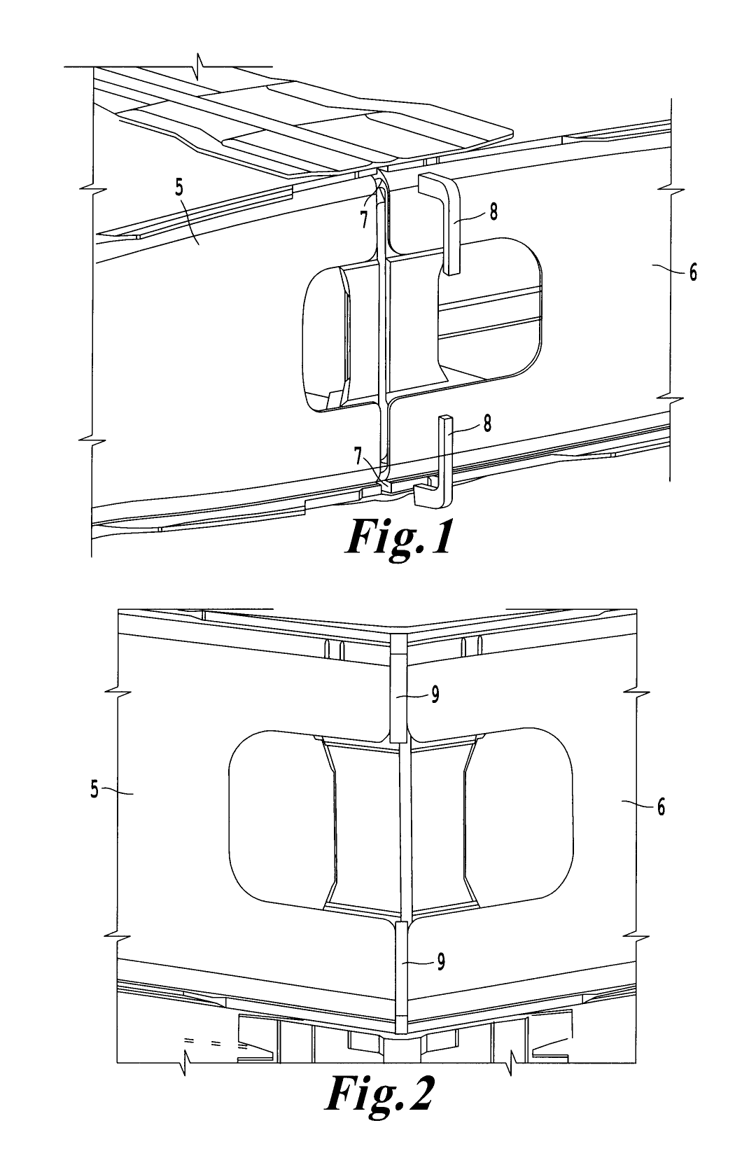

The concept used until now in joining torsion boxes of aircraft is shown in FIGS. 1 and 2. FIG. 1 shows the torsion boxes 5 and 6 which must be joined together, said joint being carried out on the outer part of the joint of torsion boxes such that the cavities or gaps 7 which must be covered once the boxes 5 and 6 are joined are covered by means of sealing parts 8 especially designed for such effect. Once the sealing parts 8 are placed in the joint of the boxes 5 and 6 (FIG. 2), it is necessary to flood the areas 9 with sealant material so that the joint does not have leaks. The enormous amount of sealant used to flood the areas 9 causes the sealant to crack over time, as mentioned above, which generates the occurrence of new leak paths for the fuel. In addition to the sealant cracking, the parts 8 with a special design are secured to the structure of the torsion box only by means of the grip of the sealant material itself, generating maintenance problems therein due to the operative life itself of the aircraft, which is subjected to loads and vibrations.

The new concept of the device 1 of the invention consists of attacking the fuel leak from its start, i.e., from inside the torsion box, 5 or 6, making a device 1 designed with three sides, 2, 3 and 4, said device 1 being installed in the process of assembling the torsion boxes 5 and 6. Said device 1 is fixed to the joint of the boxes 5 and 6 such that it is completely impossible for it to become detached therefrom, thus preventing future problems in the service life of the aircraft.

The mentioned device 1 is installed inside the joint of torsion boxes 5 and 6, unlike the known sealing parts 8, which are installed from the outside of the mentioned boxes, 5 and 6. Furthermore, as a result of the three-sided geometry of the device 1, perfect sealing of the existing cavities or gaps 7 is assured.

The device 1 of the invention is permanently joined to the torsion boxes 5 and 6 preferably by means of the use of rivets. The device 1 is thus joined for life to the structure, improving the sealing concept in the structure itself, since it is joined from inside the torsion boxes 5 and 6, and uses a minimum amount of sealant material, which is a considerable savings in curing time and material of the structure comprising the mentioned torsion boxes 5 and 6. In addition, as a result of the three-dimensional geometry itself of the device 1, said device is able to cover the gaps or cavities 7 existing in the previous structures (FIG. 1) more effectively with respect to the known prior art. Furthermore, it is necessary in known solutions to drain the fuel from the inside of the structures and to subsequently ventilate them in order to perform the necessary maintenance tasks when the sealant material has deteriorated, which is not necessary with the permanent device 1 of the invention. The main advantages of the device 1 of the invention are to thus achieve a better sealing, which is permanent and does not require maintenance.

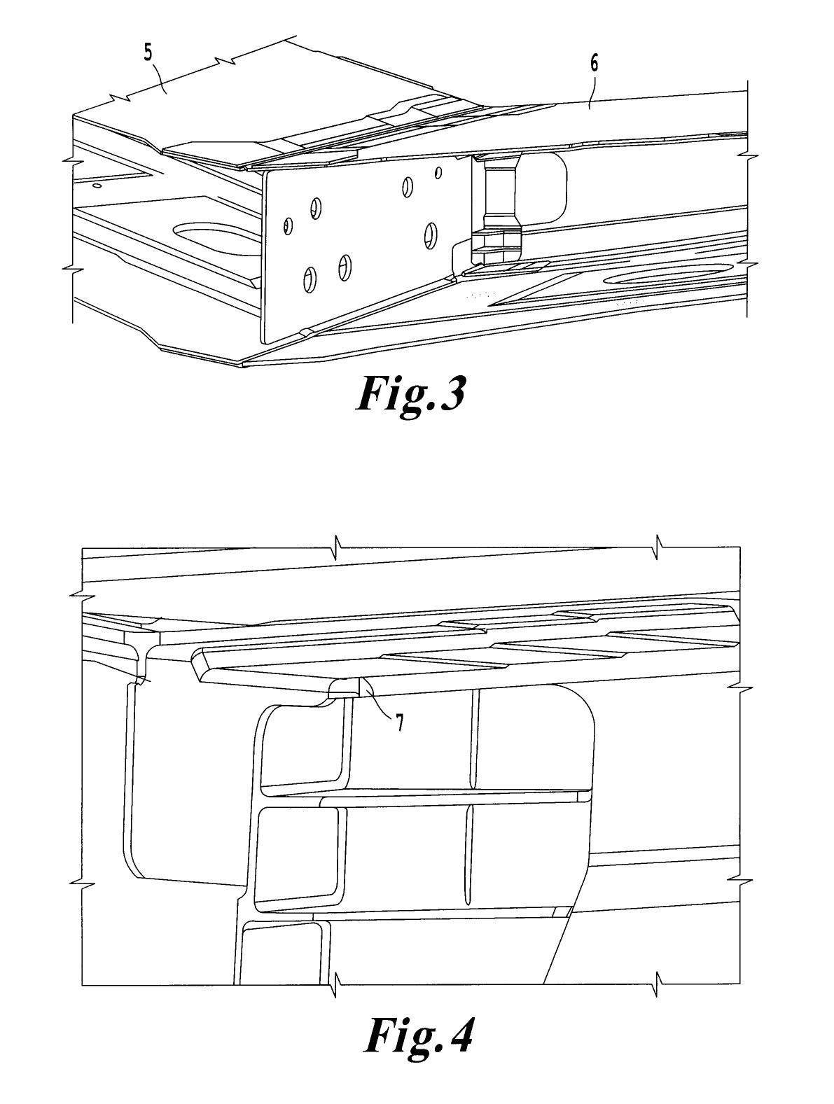

FIGS. 3, 4 and 5 show a device 1 according to the invention which is applied to the gaps or cavities 7 existing in the rear part of a joint of torsion boxes 5 and 6.

The device 1 of the invention is a non-structural device because it does not withstand the loads existing in the joint of the torsion boxes 5, 6 of the structure of the aircraft. The device 1 is thus joined in a permanent manner to the torsion boxes 5 and 6 preferably by means of the use of rivets, such that in order for the device 1 to not withstand stresses, the boreholes in which the rivets for securing the device 1 to the torsion boxes 5, 6 are arranged are somewhat larger than the diameters of the mentioned rivets.

Those modifications comprised within the scope defined by the following claims can be introduced in the preferred embodiment described above.

1. A device (1) for joining torsion boxes (5, 6) of aircraft structures, said structures carrying fuel therein, characterized in that the mentioned device (1) comprises three sides (2, 3, 4) by means of which it is secured to the inner part of the structural parts of the joint of the torsion boxes (5, 6) of the aircraft in a permanent manner, said device (1) thus closing the joint of the boxes (5, 6) and preventing possible fuel leaks, the device (1) being a non-structural component of the mentioned joint since it does not withstand the loads of the structure of the joint of torsion boxes (5, 6).

2. The device (1) for joining torsion boxes (5, 6) of aircraft structures according to claim 1, characterized in that it is placed in the joint of the torsion boxes (5, 6) during the step of assembling the mentioned boxes (5, 6) when the structures of the aircraft are formed.

3. The device (1) for joining torsion boxes (5, 6) of aircraft structures according to any of the previous claims, characterized in that it comprises small allowances between the joint of its sides (2, 3, 4) with the inside of the torsion boxes (5, 6) which are covered by means of the application of sealant material in order to thus assure perfect sealing of said device (1) during the entire useful service life of the aircraft.

4. The device (1) for joining torsion boxes (5, 6) of aircraft structures according to any of the previous claims, characterized in that it is joined to the torsion boxes (5, 6) by means of rivets.

5. The device (1) for joining torsion boxes (5, 6) of aircraft structures according to claim 4, characterized in that the boreholes in which the rivets for securing the device (1) to the torsion boxes (5, 6) are arranged are larger than the diameters of the mentioned rivets, so that the device (1) does not withstand stresses.
